(19) United States
(12) Patent Application Publication
(10) Pub. No.: US 2019/0217226 A1
(43) Pub. Date: Jul. 18, 2019

(54) Magnetic Particle Fluid Recovery System

(71) Applicant: QTI Services, LLC, Latrobe, PA (US)

(72) Inventor: Michael Kowatch, Latrobe, PA (US)

(73) Assignee: QTI Services, LLC, Latrobe, PA (US)

(21) Appl. No.: 15/872,411

(22) Filed: Jan. 16, 2018

(51) Int. Cl. B01D 29/33; B01D 61/02; B01D 15/00; B01D 35/06; B01D 29/90; G01N 27/84

(52) U.S. Cl. CPC B01D 29/333; B01D 61/025; B01D 15/00; B01D 35/06; C01B 13/115; G01N 27/84; B01D 2311/2626; B01D 2201/165; B01D 2201/26; B01D 29/902

(57) ABSTRACT

A magnetic particle carrier fluid recovery system includes at least one filter and a fluorescence reducer in fluid communication with contaminated magnetic particle carrier fluid. The filter(s) removes particulate matter less than 1 micron in size. The fluorescence reducer removes soluble fluorescent compounds from the carrier fluid causing background fluorescence contamination. A pump circulates the carrier fluid from a reservoir of contaminated fluid, through the system, and back to the reservoir. A cleaning loop runs the carrier fluid through the filter(s) and fluorescence reducer to remove contaminants to levels acceptable for new magnetic particle carrier fluid. A testing loop may be included that bypasses the filter(s) and fluorescence reducer. A valve may be actuated to toggle between the testing loop and cleaning loop for selective cleaning or use of the carrier fluid for MPI testing. The system may be integrated with an MPI station or may be independent and mobile.

### FIELD OF THE INVENTION

This invention relates to systems for cleaning magnetic particle carrier fluid, and more particularly, for the removal of particulate and fluorescence contamination from magnetic particle carrier fluid, which may then be conditioned for reuse.

### BACKGROUND

Non-destructive magnetic particle inspection (MPI) is frequently used to test manufactured machine parts or components for discontinuities such as cracks that create structural instability in the part. MPI is commonly used in the aerospace industry for testing components of planes, helicopters, weapons, missiles, for example, although many other industries utilize MPI as well. Generally, MPI involves applying ferromagnetic particles to the part being tested, which is then subjected to a magnetic field. The ferromagnetic particles collect in the cracks and other surface discontinuities, revealing their existence. The ferromagnetic particles may be iron, nickel, cobalt, or alloys that have magnetic properties. In some versions of MPI, the ferromagnetic particles are visible by visual inspection. In other versions, the ferromagnetic particles may be coated with fluorescent pigments that may be seen with a black light or UV light to visualize the cracks and imperfections of the tested component where the particles settle or adhere.

MPI may be performed as either dry particle MPI, where the particles are dusted over the tested component, or wet particle MPI there the ferromagnetic particles are suspended in a carrier fluid or vehicle, which may be water or petroleum-based fluid like mineral spirits. In the case of wet particle MPI, the fluid with suspended ferromagnetic particles is sprayed onto a component being tested, and the excess magnetic particle carrier fluid is collected for reuse. As the magnetic particle carrier fluid is used throughout repeat testing, it begins to accumulate dust from the air and testing equipment, as well as rust or metal shavings from the component being tested. This particulate matter makes the carrier fluid cloudy and change color from clear to brown, orange or grey. This change in color and opacity renders the ferromagnetic particles more difficult to perceive during testing, and may interfere with their ability to settle in or adhere to the structural imperfections of a component. In addition, the magnetic particle carrier fluid loses ferromagnetic particles over time with use as they adhere to tested component, also making the testing less effective over time. Also, fluorescent pigments leech off the ferromagnetic particles and into the carrier fluid over time, accumulating within the carrier fluid. If too high a concentration of fluorescence is in the carrier fluid, the background fluorescence is too high to clearly see where the ferromagnetic particles are located on tested component, thus interfering with MPI testing.

The use of MPI is very regulated. Carrier fluid must comply with AMS 2641A “Vehicle, Magnetic Particle Inspection” or similar industry regulation, and must also pass ASTM E1444 for viscosity, fluorescence, flash point, and many other factors. For wet particle MPI, contamination levels must also be kept in accordance with ASTM E1444, §§ 7.2.1.1 and 7.2.1.2. For example, magnetic particle carrier fluid may only be used if total contaminants remain below 30% by visual inspection, the viscosity is no higher than 3.0 centistokes (cSts) at 100° F., and the fluorescence is not greater than that of a 10-ppm solution of quinine sulfate dihydrate in 0.1 N sulfuric acid, as well as many other requirements. Magnetic particle carrier fluid is routinely inspected before each round or day of testing at an MPI station. If a batch of magnetic particle carrier fluid fails AMS 2641A, ASTM E1444, or other relevant industry regulation, the industry practice is to discard the batch of magnetic particle carrier fluid and replace it with new carrier fluid and new ferromagnetic particles. Depending on use, this means replacement of the magnetic particle carrier fluid every month or so, which can be significant since a typical batch of magnetic particle carrier fluid may be 20 gallons or more.

The used, unsuitable magnetic particle carrier fluid must be stored until it can be transported for proper disposal, and there are costs associated with storage, transportation and disposal. In addition, the carrier fluid is very expensive, and must be repurchased each time a new batch is required. Additional ferromagnetic particles must also be purchased and added to the carrier fluid for use. All of these costs, which can be significant over time, could be avoided if there was a way to clean the magnetic particle carrier fluid to reduce or eliminate the contamination, allowing the carrier fluid to be recycled or reconditioned for reuse.

### SUMMARY

A system for cleaning magnetic particle carrier fluid is disclosed, which removes contamination from used magnetic particle carrier fluid and allows it to be reconditioned for further use. The present system includes a closed-system that can be integrated into a magnetic particle inspection (MPI) station, retrofit into an existing MPI station, or may be used temporarily in association with an MPI station or other reservoir of magnetic particle carrier fluid.

The system includes at least one filter capable of removing particulate matter less than 1 micron in size. The filter(s) remove dirt, debris, large particles, bits of metal and rust from tested components, fluorescent dye that may flake off the ferromagnetic particles during use, and other particulate matter that may accumulate in the magnetic particle carrier fluid over time and/or with use. Various mesh or pore sizes may be employed in the filter(s), and magnetic or other types of filters may be used. The system also includes a fluorescence reducer in fluid communication with the filter(s), which may be a component part of the filter(s), such as activated carbon or ozone from an ozone generator. The fluorescence reducer removes soluble fluorescent compounds that may leech into the magnetic particle carrier fluid and create background fluorescence contamination. The system may include any number, type, and combination of filter(s) and fluorescence reducer.

The system preferably includes a housing that retains the filter(s) and fluorescence reducer therein. An inlet providing ingress of contaminated magnetic particle carrier fluid and an outlet providing egress of clean magnetic particle carrier fluid may be provided in the housing, or may be otherwise in fluid communication with at least one of the filter(s) and fluorescence reducer, an indeed may be directly connected thereto. The system also includes conduit to conduct the magnetic particle carrier fluid to and from the reservoir.

The system may include a pump or utilize the circulating pump that is part of existing magnetic particle test equipment, configured to circulate the magnetic particle carrier fluid from the reservoir, to the inlet, through the filter(s) and fluorescence reducer, to the outlet, and from the outlet back to the reservoir. Contaminated magnetic particle carrier fluid enters the filter(s) and fluorescence reducer, and clean magnetic particle carrier fluid exits and returns to the reservoir. Low flow rates may be employed for optimal pump life and filtering efficiency, such as around 1-5 gallons per minute, and preferably around 1.5 gallons per minute. A pressure gauge may be included in the system downstream of the pump and upstream of the filter(s) to monitor system pressure, and therefore, the operating efficiency of the filter(s). When the pressure begins to build, the filter(s) and other system components may be cleaned and/or replaced.

In some embodiments, the system includes a cleaning loop as described above, as well as a testing loop. The testing loop bypasses the filter(s) and fluorescence reducer, permitting the circulation of the magnetic particle carrier fluid without cleaning, such as during MPI inspection testing. When cleaning is desired, a valve may be actuated, such as with an actuator, that diverts the flow of magnetic particle carrier fluid from the testing loop into the cleaning loop. When cleaning is complete, the valve may be toggled back to the testing loop. Accordingly, the system may remain attached to or associated with an MPI station and permit selective cleaning of the magnetic particle carrier fluid for recycling or maintenance. In some embodiments, the system may be secured to a mobile support for transportation between locations, such as for use with multiple different MPI stations or contaminated magnetic particle carrier fluid reservoirs.

The cleaning system as described herein removes particulate and fluorescence contamination sufficient to pass regulation standards for new wet particle magnetic particle carrier fluid, including the AMS 2641A and ASTM E1444. For instance, the system cleans the carrier fluid to less than 30% particulate contamination, maintains the viscosity as less than 3.0 centistokes at 100° F., and a fluorescence of less than that of a 10-ppm (1.27×10⁻⁵ molar) solution of quinine sulfate dihydrate in 0.1 N sulfuric acid as compared under black light. It also reduces color and turbidity of the magnetic particle carrier fluid, as well as removes odors that may linger on the fluid.

Once cleaned, the magnetic particle carrier fluid may be reconditioned by adding new ferrogmagnetic particles to the cleaned fluid. These particles may be fluorescent or non-fluorescent. The renewed magnetic particle carrier fluid is then ready for reuse. Accordingly, the present system removes the need to store, transport, and dispose of contaminated and used magnetic particle carrier fluid, translating to significant cost savings.

The magnetic particle carrier fluid recovery system, together with its particular features and advantages, will become more apparent from the following detailed description and with reference to the appended drawings.

### DESCRIPTION OF THE DRAWINGS

FIG. 1 is a schematic diagram of one embodiment of the magnetic particle fluid recovery system of the present invention.

FIG. 2 is a schematic diagram of an alternative embodiment of the magnetic particle fluid recovery system of the present invention.

FIG. 3 is an illustrative diagram of the embodiment of FIG. 1, in use as a mobile unit in association with a magnetic particle inspection station.

FIG. 4 is an illustrative diagram of a mobile embodiment of the magnetic particle fluid recovery system of the present invention, in use in association with a reservoir.

FIG. 5 is an illustrative diagram of an embodiment of the magnetic particle fluid recovery system having multiple filters.

FIG. 6 is an illustrative diagram of a cross-section of one example of a filter.

FIG. 7 is an illustrative diagram of an embodiment of the magnetic particle fluid recovery system including a filter and an ozone generator.

FIG. 8 is a schematic diagram of a second embodiment of the magnetic particle fluid recovery system of the present invention having an operational loop and a cleaning loop.

FIG. 9 is an illustrative diagram of the embodiment of FIG. 8, integrated with a magnetic particle inspection station.

FIG. 10 is an illustrative diagram of the embodiment of FIG. 8 having a single filter.

FIG. 11 is an illustrative diagram of another embodiment of FIG. 8 having a carbon filter and a magnetic particle filter.

FIG. 12 is an illustrative diagram of the housing of one embodiment of the magnetic particle recovery system of FIG. 8.

FIG. 13 is an illustrative diagram of the top of the housing of FIG. 12.

Like reference numerals refer to like parts throughout the several views of the drawings.

### DETAILED DESCRIPTION

As shown in the accompanying drawings, the present invention is directed to a system 100 for cleaning magnetic particle carrier fluid 10 for reconditioning and/or reuse. As used herein, the terms “cleaning” and “recovery” may be used interchangeably, and refer to a process for reducing contamination in a fluid. Specifically, the system 100 includes components that remove both particulate and fluorescence contamination from magnetic particle carrier fluid that can accrue as the carrier fluid is used during magnetic particle inspection. As used herein, the terms “magnetic particle carrier fluid,” “carrier fluid,” carrier vehicle,” “vehicle fluid,” and “vehicle” may be used interchangeably to refer to the fluid used in magnetic particle inspection in which magnetic particles is suspended. The magnetic particles suspended in the carrier fluid may be fluorescent or not fluorescent. The system 100 can be used to clean magnetic particle carrier fluid of the carrier I or carrier II type, which may be water or petroleum-based carrier fluids.

In at least one embodiment, as shown throughout the Figures, the system 100 includes at least one filter 110 configured to remove particulate matter from contaminated magnetic particle carrier fluid, preferably as it flows therethrough. For example, as magnetic particle carrier fluid is used during MPI inspection, it can accumulate dirt and dust from the environment, rust from the machinery, and debris and flakes of metal or other materials that come off the component piece being tested or other machinery. The magnetic particles themselves may become damaged over time, breaking into smaller pieces. The fluorescent dye with which the magnetic particles may be coated can also shed off the magnetic particles, which may be present as physical particulates or soluble within the magnetic particle carrier fluid.

The filter 110 receives the contaminated magnetic particle carrier fluid and removes such particulate matter from the fluid. Accordingly, at least one filter 110 is configured to remove particles less than 1 micron in size, indeed as small as 0.1 microns, from the magnetic particle carrier fluid. Such sizing provides effective filtration of both magnetic particles, which average about 6 microns in size, as well as smaller fragments of fluorescent dye particulates. In certain embodiments, the at least one filter 110 is configured to remove particulates up to 10 microns in size from the carrier fluid. This range effectively captures the majority of the magnetic particles, dirt and debris that accumulates in the carrier fluid. In still other embodiments, the at least one filter 110 is configured to remove particles up to 50 microns in size from the magnetic particle carrier fluid. This range filters larger particles as well, such as rocks or larger fragments of machinery or tested components that may detach during MPI testing. These size ranges are illustrative of the capabilities of the filter 110, and are not intended to be limiting.

Any type of filter capable of fluid filtration is contemplated. For instance, in some embodiments, the filter(s) 110 may include structure such as mesh having holes that restricts matter from passing through which exceeds the size of the holes, while permitting passage of smaller matter, including fluid. Examples include, but are not limited to, the Whirlpool WHA4FF5 pleated carbon water filter having a filtration size of less than 1 micron (Whirlpool Corp., manufactured by Ecodyne Water Systems of St. Paul, Minn.); the EcoPure EPW4F pleated carbon water filter having a filtration size of less than 1 micron (EcoPure Water Products, Woodbury, Minn.); and the 5 Micron Big Blue Coconut Shell Carbon Block Water Filter Cartridge having carbon block of fine coconut shell, including activated carbon, and a filtration size of 5 microns (Aquaboon LLC, Oceanside, N.Y.). The mesh component of such filters 110 may be made of any suitable material, such as paper, carbon, cellulose-based material, and plant-based material such as coconut. Carbon filters may or may not include activated carbon. The filter 110 may have any suitable configuration to provide filtration of particles, such as but not limited to planar, cylindrical, tubular, pleated, and any combinations thereof.

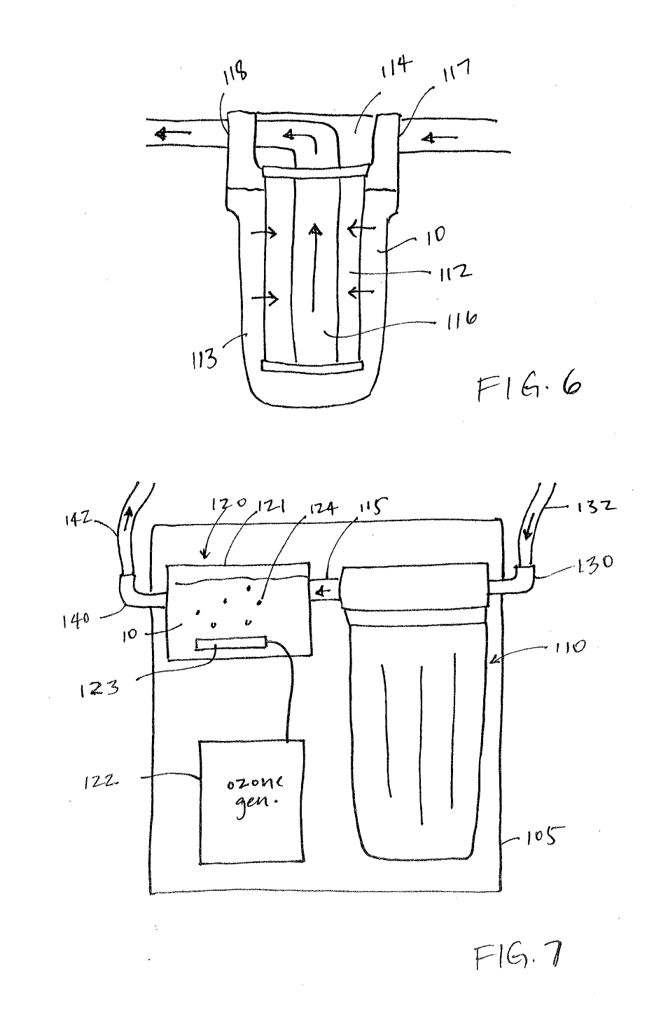

For instance, in at least one embodiment, the filter(s) 110 may be cylindrical or tubular filters as illustrated in FIGS. 5 and 6. Such filter(s) 110 may include a cartridge 112 made of the filtering mechanism, such as mesh or carbon, which may be pleated as demonstrated in the partial cross-section of FIG. 5, although a pleated configuration is not required. The filter 110 may include a sump 113 or similar housing dimensioned to receive and retain a cartridge 112 therein. A cap 114 may correspond with and engage the sump 113 to form a top, effectively enclosing the cartridge 112. The filter 110 may further include a filter inlet 117 and filter outlet 118, as illustrated in FIG. 6. The magnetic particle carrier fluid follows a fluid flow path indicated by the arrows, and enters the filter 110 through the filter inlet 117. The cartridge 112 may include a channel 116, or otherwise form a tubular configuration such that magnetic particle carrier fluid passes through the cartridge 112 from one side to the other. As demonstrated in FIG. 6, this may be in a direction from the outside of the cartridge 112 to the channel 116 formed at the interior side thereof. As the magnetic particle carrier fluid passes through the cartridge 112, particulate matter is restricted from passage according to the size of the mesh of the cartridge 112. Once through the cartridge 112, the magnetic particle carrier fluid continues out the filter 110 through the filter outlet 118. This is but one illustrative example of how the filter 110 may operate, and is not intended to be limiting.

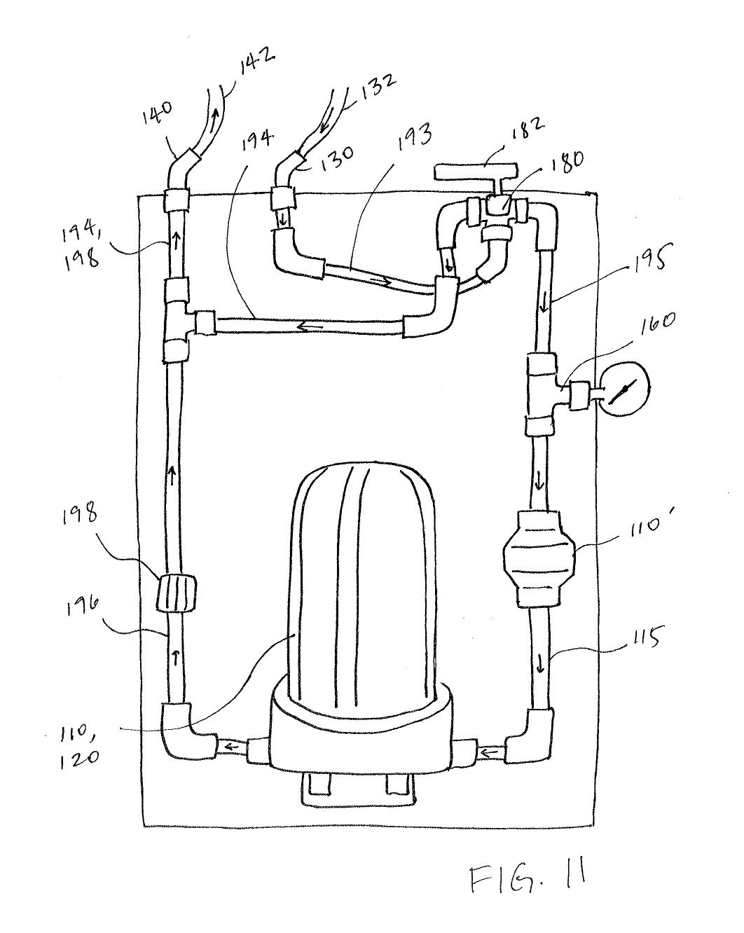

In other embodiments, the at least one filter 110 may comprise a magnetic filter 110′, as depicted in FIG. 11. Such magnetic filter 110′ does not have mesh, but instead includes one or more magnets that attract the ferromagnetic particles from the carrier fluid and sequester them as the fluid passes through the filter 110′. In some embodiments, such magnetic filters 110′ may include a strong permanent magnet(s), such as but not limited to ferric materials such as ceramic ferrite or neodymium, that attracts magnetic particles as they pass by. In other embodiment, the magnetic filter 110′ may be electromagnet(s) that attract magnetic particles upon the application of energy, such as electricity, to the electromagnet(s). Accordingly, the magnetic filter 110′ may filter particles of any size so long as they are magnetically responsive, depending on the size of the particles to be removed and strength of the magnet. For example, in at least one embodiment, the magnetic filter 110′ may be a Magnom™ filter of a mini, midi, or max range model (Magnom Corp., Warwick, England) capable of filtering ferromagnetic particles as small as 0.07 microns. The magnetic filter 110′ may be configured as an inline filter as shown in FIG. 11, or may otherwise be inserted in or access the pipeline of the system 100. The magnetic filter 110′ may be temporarily removed from the line and cleaned for maintenance, and is therefore reusable.

In still other embodiments, the filter(s) 110 may be a reverse osmosis unit. The reverse osmosis unit may include a cartridge 112, sump 113, and cap 114 as described above, but may also include its own storage tank to collect fluid following filtration, but before proceeding to the remainder of the system 100. A reverse osmosis filter may used to filter dissolved inorganic materials in the magnetic particle carrier fluid, such as salts, as well as very small particles. It employs pressure to force the fluid through the filtration membrane, such as the cartridge 112. Accordingly, higher system pressures such as 30-85 psi may be used if reverse osmosis filter(s) are included in the system 100, although higher or lower pressures may still be used with reverse osmosis filters.

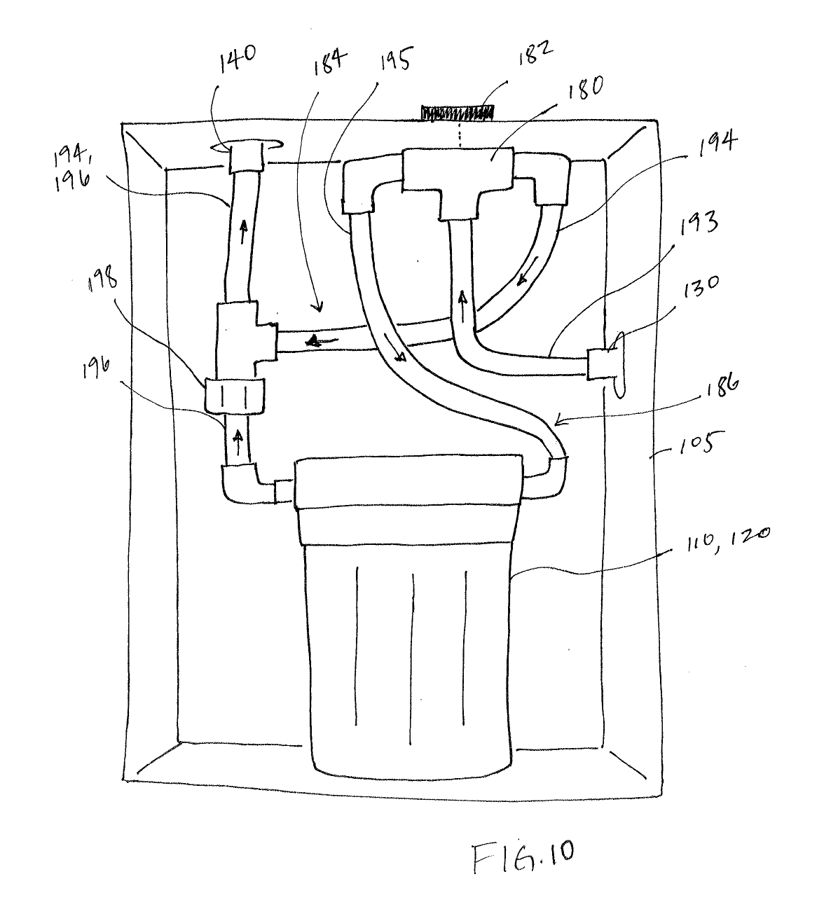

The system 100 may include any number of filters 110, in any combination of types of filters 110. For example, in one embodiment the system 100 includes only a single filter 110, as depicted in FIG. 10. In other embodiments, the system 100 may include multiple filters 110, as in FIGS. 5 and 11. These filters may be the same type, such as both carbon filters as in FIG. 5, or may be different types, such as one magnetic filter 110′ and one carbon filter 110 as in FIG. 11. Even if the same type of filter, the filters 110 may be the same model or different models from one another. Various numbers and types of filters 110 may be included in the system 100 depending on the application and composition of the magnetic particle carrier fluid. For example, a first filter 110 may be provided that removes larger particles, such as in the range of 5-10 microns. A second filter 110 downstream of the first filter may remove smaller particles, such as in the range of 0.05-0.1 microns. A magnetic filter 110′ may be used as a first filter, as in FIG. 11, to remove the ferromagnetic particles, and a carbon filter 110 having a 0.1 micron mesh may be included as a second filter to remove fine particles from the carrier fluid. These are a few examples, and are not intended to be limiting.

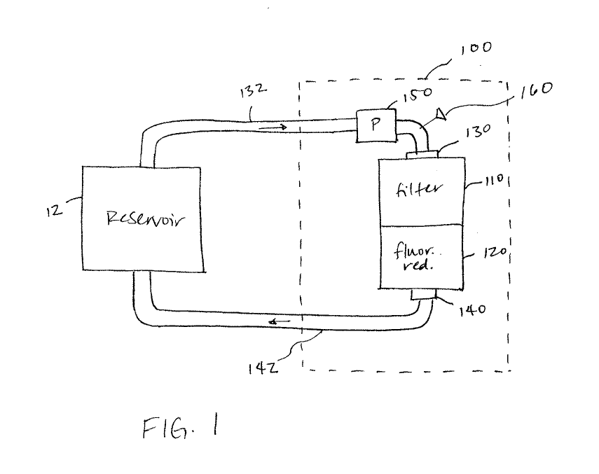

The system 100 further includes a fluorescence reducer 120 in fluid communication with the at least one filter 110, as depicted in FIGS. 1, 2 and 8. The fluorescence reducer 120 is configured to remove soluble fluorescent compounds from the magnetic particle carrier fluid that may have leeched into the fluid from the fluorescent dye on the ferromagnetic particles over time and/or use. In at least one embodiment, the fluorescence reducer 120 may be a component of or integrated with the at least one filter 110. For instance, a carbon filter may be a filter 110, and may include activated carbon in the cartridge 112 that functions as a fluorescence reducer 120. In such embodiments, the activated carbon may attract the fluorescent compounds from the carrier fluid, and may adsorb the fluorescent compounds to the cartridge 112 of the filter 112. Any grade or amount of activated carbon may be used as a fluorescence reducer 120, and may be a part of or separate from a filter(s) 110.

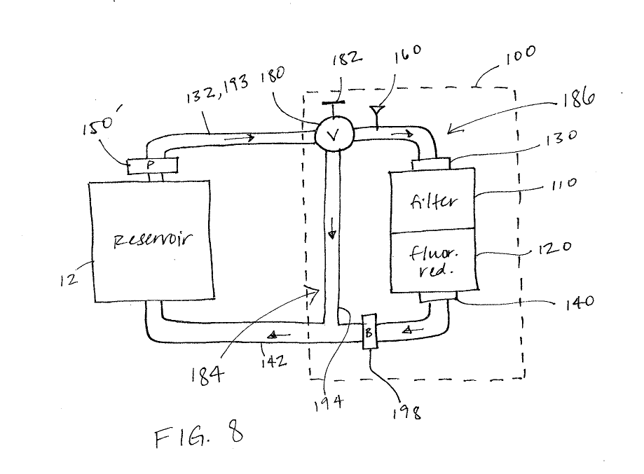

In some embodiments, as in FIG. 7, the fluorescence reducer 120 may be ozone 124 created by an ozone generator 122. The ozone generator 122 may be a motor that is electrically operated and connected to an ozone output 123, such as an electrode, that is submerged in magnetic particle carrier fluid retained within an ozone tank 121. As voltage, current, or electricity is passed through the ozone generator 122, the ozone output 123 reacts with oxygen in the magnetic particle carrier fluid to produce ozone 124, which bubbles through the magnetic particle carrier fluid. The ozone generator 122 is preferably capable of ozone production in range of 50-120 kg O₃ per hour, depending on whether air or oxygen is fed to ozone generator, although other ranges are also contemplated and within the spirit of the invention. The created ozone 124 reacts with organic molecules and other compounds in the magnetic particle carrier fluid, including soluble fluorescent compounds, to neutralize the compounds, which may occur through oxidation. This chemical reaction renders the fluorescent compounds no longer fluorescent, thereby reducing the background levels of fluorescence of the magnetic particle carrier fluid that is considered a contaminant in the MPI industry. The ozone 124 may also react with and neutralize other organic compounds in the magnetic particle carrier fluid that can contribute to discoloration, inorganic molecules like iron, and biological contamination from bacteria that may have been introduced to the magnetic particle carrier fluid from the environment during use. Because the ozone generator 122 creates ozone 124 from oxygen in the magnetic particle carrier fluid, it may be more effective with water-based magnetic particle carrier fluids, although it may also be used with oil or petroleum-based magnetic particle carrier fluids. Exemplary ozone generators 122 that may be used include the TGOGS™ ozone generation system for water purification (Toshiba Infrastructure Systems & Solutions Corp., Japan), and the Titan series ozone generators (models Titan 30, 60, 80, and 100 from Absolute Ozone®, Edmonton, AB, Canada). These are a few illustrative examples, and are not intended to be limiting.

In still other embodiments, the fluorescence reducer 120 may be a reverse osmosis membrane, such as may be implemented in a filter 110 described above. In further embodiments, the fluorescence reducer 120 may be a liquid or solution that is added to the magnetic particle carrier fluid which binds or reacts with the fluorescent compounds in the carrier fluid to neutralize, sequester, or chemically alter them so they are no longer fluorescent. These are just a few examples.

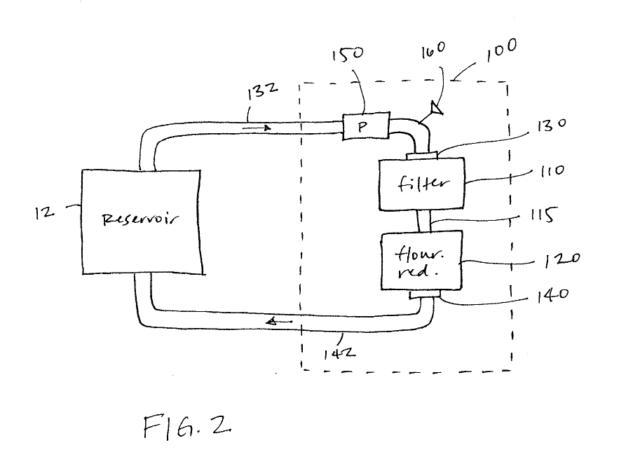

In some embodiments, the at least one filter 110 and fluorescence reducer 120 may be within the same component of the system 100, as described above. In such embodiments, they are in fluid communication with one another because they are within or part of the same component. In other embodiments, as depicted in FIGS. 2 and 7, the filter(s) 110 and fluorescence reducer 120 may be interconnected in fluid communication by an intermediate conduit 115. This intermediate conduit 115 may be any form of piping, tubing, or similar material of any suitable dimension and configuration to facilitate fluid transfer of the magnetic particle carrier fluid between the filter(s) 110 and fluorescence reducer 120. Further, the filter(s) 110 and fluorescence reducer 120 may be in any order in the fluid flow path, and may indeed occur at the same point in the fluid flow path.

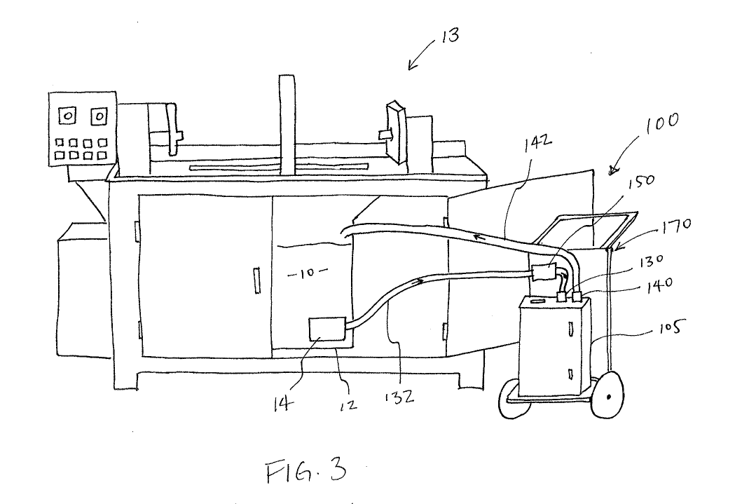

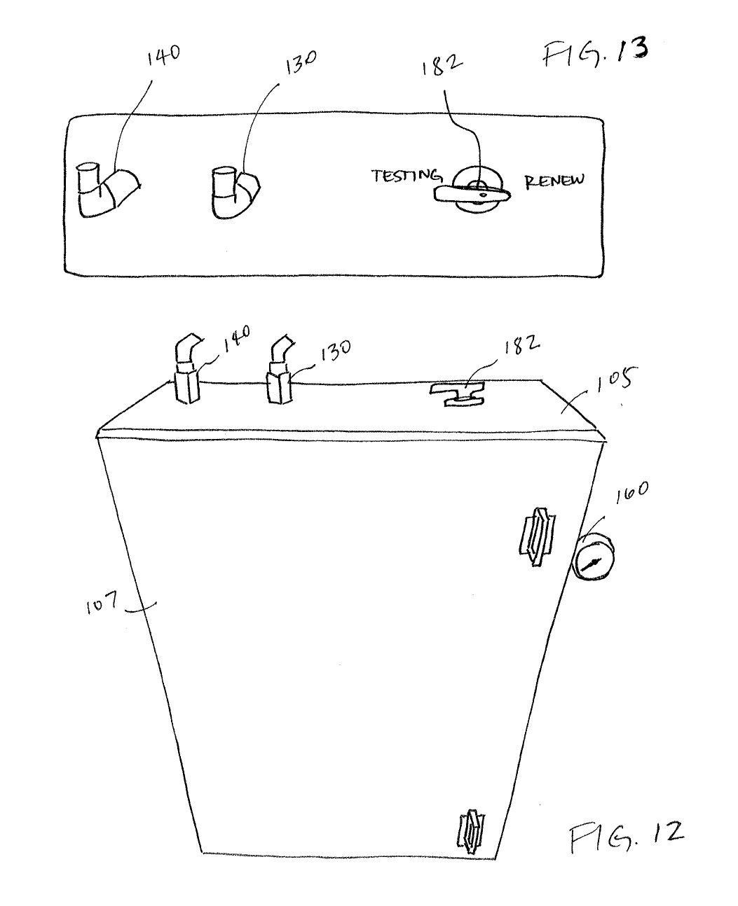

In at least one embodiment, the system 100 includes a housing 105 configured to retain the filter(s) 110 and fluorescence reducer 120 therein. The housing 105 may be made of any suitable material, such as metals, metal alloys, and polymeric materials that may be inert with respect to the magnetic particle carrier fluid and ferromagnetic particles contained therein. The housing 105 preferably includes a hollow interior in which the filter(s) 110, fluorescence reducer 120, and intermediate conduit 115 is positioned. In at least one embodiment, as in FIGS. 3, 5, 7, 9, 10, 12 and 13, the housing 105 substantially surrounds the filter(s) 110 and fluorescence reducer 120. A door 107 may be provided, as shown in FIGS. 5 and 12, to allow selective access to the interior space of the housing 105, and accordingly to the filter(s) 110 and fluorescence reducer 120, and may be closed and latched shut for operation, transport, and storage. The filter(s) 110 and fluorescence reducer 120 may be secured within the interior of the housing 105 in any configuration as may be desired or dictated by the components, such as to the floor as in FIG. 11, or suspended within the interior as in FIGS. 5 and 10.

In at least one embodiment, as seen throughout the Figures, the system 100 includes a first conduit 132 in fluid communication with a reservoir 12 of contaminated magnetic particle carrier fluid. The first conduit 132 may be pipe, tubing, or any kind of hollow device capable of transporting fluid from one location to another. The first conduit 132 may therefore be made of any suitable material, such as but not limited to plastics, polymer-based material, metals, and alloys, and is preferably inert or non-reactive with the components of the magnetic particle carrier fluid. The first conduit 132 may follow any path leading away from the reservoir 12, and may have any number of bends, angles, joints, or other mechanisms to change the direction of the first conduit 132.

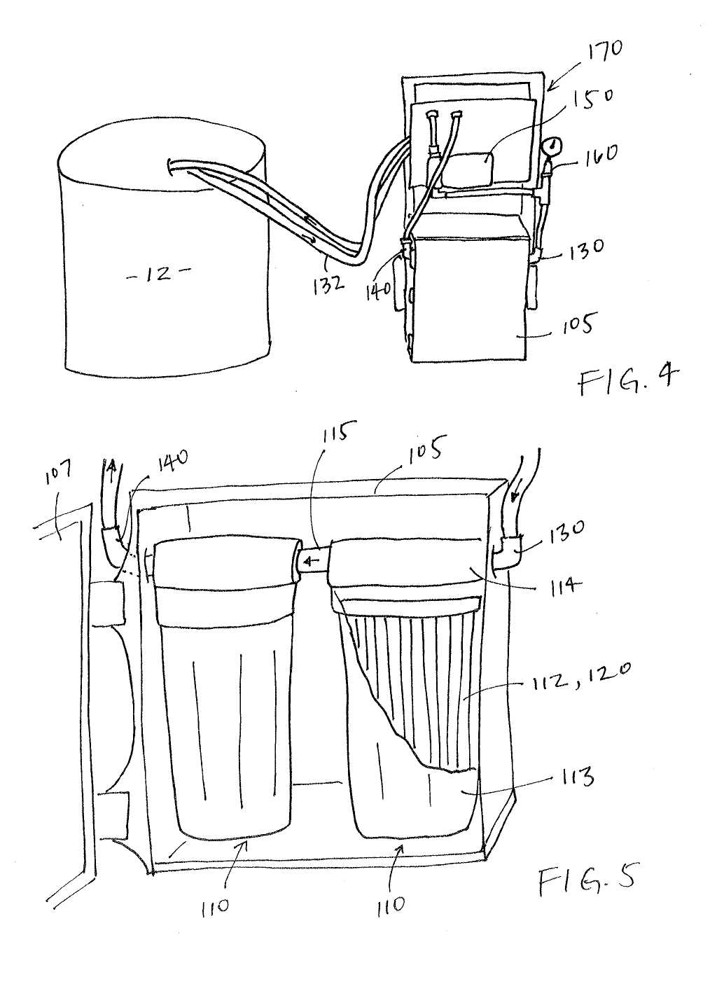

The reservoir 12 may be a collection tank associated with a magnetic particle inspection (MPI) station 13 as depicted in FIGS. 3 and 9, or may be a stand-alone tank of contaminated or used magnetic particle carrier fluid as in FIG. 4. Accordingly, the present invention contemplates use in association with an MPI station 13, such as during down time when inspections are not being conducted, as well as recovery of contaminated magnetic particle carrier fluid which may be too contaminated for use in MPI according to regulations or industry standards.

The system 100 also includes a pump 150 configured to circulate the magnetic particle carrier fluid from the reservoir 12 and through the various components of the system 100, beginning with the first conduit 132. In some embodiments, as in FIGS. 1 and 2, the pump 150 may be part of the system 100, which may be mobile and can be transported from one MPI station 13 to another to clean carrier fluid as needed. In other embodiments, as in FIG. 9, the circulation pump 150′ of an MPI station 13 may be used with the system 100 to circulate the magnetic particle carrier fluid for cleaning. Such embodiments may be used when the system 100 is incorporated or integrated into an MPI station 13 and remains at that location.

Regardless of location, the pump 150 has sufficient power and capacity to move the contaminated magnetic particle carrier fluid through the system 100. For instance, in at least one embodiment, the pump 150 is capable of creating a flow rate of magnetic particle carrier fluid in the range of up to 5 gallons per minute. A pump such as the utility pump model 2088-394-144 manufactured by Shurflo (Costa Mesa, Calif.) is one example, although others are also contemplated, such as, but not limited to, utility pump model 11810-0003 made by Xylem/Jabsco (Beverly, Mass.). It is contemplated that the cleaning of contaminated magnetic particle carrier fluid with the system 100 may preferably occur when an MPI station is not in use conducting inspections. Therefore, speed is not a primary factor. The system 100 may be run for as long as it takes to obtain cleaned magnetic particle carrier fluid. Depending on the configuration of the system 100, the volume, level, and type of contamination of the magnetic particle carrier fluid, the cleaning process may take up to 2 hours, or may be run overnight to ensure a thorough cleaning. The lower the speed of the pump 150, the less likelihood there is that the pump 150 will overheat (which may occur around 140° F. for some pumps). In at least one embodiment, for instance, the pump 150 may provide a flow rate of 1.5 gallons per minute. This flow rate has been found to keep the pump 150 operating at around 100° F. when processing 20 gallons of fluid. It should be noted, however, that other flow rates are also contemplated, including up to 60 gallons per minute and above.

As shown in FIGS. 1, 2, 8 and 11, the system 100 may also include a pressure gauge 160 located downstream of the pump 150 and in fluid communication with the circulating magnetic particle carrier fluid exiting from the pump 150. As used herein, “downstream” means in the direction of fluid flow through the system 100, and “upstream” means in the direction opposite of fluid flow through the system 100. The pressure gauge 160 is positioned to monitor the pressure of the system 100, which is an indicator of the operational status of the filter(s) 110 and other downstream components. For instance, if the filter(s) 110 or downstream component(s) become clogged, such as with particulate matter from contaminants, the pressure of the system 100 will increase. Similarly, if the flow rate of fluid exiting the pump 150 is too high, the resulting pressure may be too high for the filter(s) 110 or downstream components to operate efficiently. In at least one preferred embodiment, the system 100 may operate at a pressure in the range of 0 to 10 psi, and most preferably between 1 to 2 psi. Unless the system 100 includes a reverse osmosis unit or other component that would require higher pressures, pressures exceeding 30 psi should be avoided as they indicate accumulation of particulates in the system 100 that can impair functioning. When the pressure reaches 25 psi, the component(s) of the system 100 such as filter(s) 110 should be cleaned of particulate matter, debris and sediment or replaced with new parts. In other embodiments, higher pressures may be tolerated within operating parameters, depending on the specifications of the downstream components, such as up to 60 psi or higher. For example, larger components or filter(s) 110, or those having a large surface area for contacting the magnetic particle carrier fluid, are capable of tolerating higher pressures and/or volumes of fluid. Similarly, reverse osmosis units may require operating pressures that exceed 30 psi.

The system 100 further includes an inlet 130 in fluid communication with at least one of the filter(s) 110 and fluorescence reducer 120, as depicted in FIGS. 1, 2, and 8. The inlet 130 is also in fluid communication with the first conduit 132, and therefore provides a connection between the first conduit 132 and at least one of the filter(s) 110 and fluorescence reducer 120. Accordingly, the inlet 130 may provide a sealed junction for the transmission of magnetic particle carrier fluid into at least one of the filter(s) 110 or fluorescence reducer 120. The inlet 130 may provide direct access to either the filter(s) 110 or the fluorescence reducer 120, or both if they are combined in a single component such as a carbon filter having activated carbon. The inlet 130 may be physically connected to the filter(s) 110 or fluorescence reducer 120, or may be physically separated therefrom but still in fluid communication therewith. For example, the inlet 130 may be located on the housing 105, such as shown in FIGS. 3, 5, 7, 9, and 11-13, thus serving as the entry point for the magnetic particle carrier fluid into the treatment area. The inlet 130 may be any appropriate sealing junction, such as but not limited to tubing connector, seal, and nut. The inlet 130 may be made of metal, metal alloys, plastics, rubber, polymeric materials, or other suitable material that is inert to the magnetic particle carrier fluid. It may be the same or different material from that of the first conduit 132, filter(s) 110, or fluorescence reducer 120.

The system 100 similarly includes an outlet 140 in fluid communication with at least one of the filter(s) 110 and fluorescence reducer 120, as depicted in FIGS. 1, 2, and 8. The outlet 140 may be the same or similar to the inlet 130 as described above, but provides egress of the magnetic particle carrier fluid out of the treatment area. Accordingly, the outlet 140 may be located physically connected to one of the filter(s) 110 or fluorescence reducer 120, or may be located on the housing 105 as shown in FIGS. 3, 5, 7, 9, and 11-13.

The system 100 also includes a second conduit 142, as in FIGS. 1, 2, and 8. The second conduit 142 is in fluid communication between the outlet 140 and the reservoir 12 and directs the transmission of magnetic particle carrier fluid away from the filter(s) 110 and fluorescence reducer 120, and from the housing 105 in embodiments that employ a housing 105. Accordingly, the second conduit 142 directs the movement of cleaned magnetic particle carrier fluid that has been processed and cleaned by the filter(s) 110 and fluorescence reducer 120. The second conduit 142 may be similar to the first conduit 132 described above, and may be the same or different material. The second conduit 142 may teiminate at, in, or within the reservoir 12 to deliver the cleaned magnetic particle carrier fluid to the interior space of the reservoir 12. The cleaned magnetic particle carrier fluid therefore mixes with contaminated magnetic particle carrier fluid still in the reservoir 12 that has not yet been processed and cleaned. As the system 100 is used, the fluid in the reservoir 12 continues to be drawn into the system 100, cleaned, and returned, the ratio of cleaned magnetic particle carrier fluid to contaminated magnetic particle carrier fluid in the reservoir 12 increases, until all or substantially all the magnetic particle carrier fluid in the reservoir 12 is cleaned to regulation standards for use. Once this has occurred, the system 100 may be powered down, and the cleaned magnetic particle carrier fluid may be used for inspection procedures.

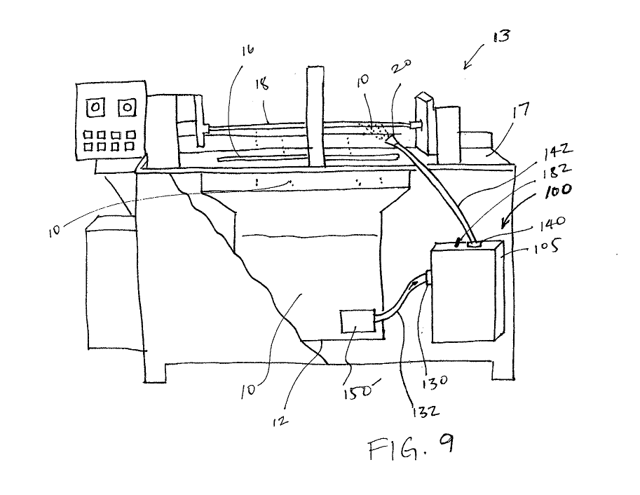

Accordingly, the system 100 includes a cleaning loop 186 in which the magnetic particle carrier fluid is directed from the reservoir 12 to the inlet 130, then to the filter(s) 110 and fluorescence reducer 120, then to the outlet 140, and back to the reservoir 12. The cleaning loop 186 may be employed to clean the magnetic particle carrier fluid. In some embodiments, however, the system 100 further includes a testing loop 184, as in FIGS. 8-13. In the testing loop 184, the filter(s) 110 and fluorescence reducer 120 of the system 100 are bypassed, thereby allowing the magnetic particle carrier fluid to return to the reservoir 12 unprocessed. The testing loop 184 may be utilized when cleaning of the magnetic particle carrier fluid is not desired, but the system 100 does not have to be disconnected or removed for the MPI station to function for testing or inspecting component parts. This is particularly useful when the system 100 is integrated into an MPI station or remains resident at a particular MPI station or other location, although remaining at the same location is not a requirement.

In embodiments having a testing loop 184 and cleaning loop 186, the system 100 includes a valve 180 in fluid communication with one of the first conduit 132 and a third conduit 193 discussed below. The valve 180 may regulate or modify the direction of fluid flow of the magnetic particle carrier fluid through the system 100. For instance, the valve 180 includes an actuator 182 that may be selectively activated, such as by turning, being depressed or lifted, or otherwise engaged, to adjust the valve 180 and change the direction of fluid flow toward either the cleaning loop 186 or the testing loop 184. In at least one embodiment, the valve 180 directs the entire flow of magnetic particle carrier fluid to either the testing loop 184 or the cleaning loop 186. In other embodiments, however, the valve 180 may regulate flow and permit flow to both loops 184, 186 simultaneously. This would result in cleaning some of the magnetic particle carrier fluid, but could be performed while inspections are being conducted at the MPI station 13. The valve 180 may therefore permit any or all of the magnetic particle carrier fluid to either loop 184, 186, in any ratio or amount. The valve 180 may be any type of suitable valve, such as but not limited to a three-way, ball, gate, globe, stopcock, or other type of valve. The actuator 182 may be any suitable mechanism for selectively engaging the valve 180, such as but not limited to a button, lever, handle, or other like mechanism. The actuator 182 may therefore be in mechanical communication with the valve 180, so that by engaging the actuator 182 the valve 180 is adjusted. In some embodiments, however, the actuator 182 may be in electrical communication with the valve 180, such as when the actuator 182 is a button or digital display. In such embodiments, an electrical signal may be sent from the processor operating the display where the actuator 182 is presented and activated to the valve 180 in order to initiate a change in state or position of the valve 180 accordingly. These are but a few examples.

In some embodiments, as in FIGS. 10 and 11, the inlet 130 and outlet 140 are located on the housing 105 of the system 100. Accordingly, the first conduit 132 directs magnetic particle carrier fluid to the inlet 130 at the housing 105. A third conduit 193 is in fluid communication between the inlet 130 and the valve 180, directing magnetic particle carrier fluid from the inlet 130 to the valve 180. As depicted in FIGS. 10 and 11, this may occur within the interior space of the housing 105. The position and state of the valve 180 defines whether the magnetic particle carrier fluid continues on to the testing loop 184 or the cleaning loop 186.

The testing loop 184 includes a fourth conduit 194 that is in fluid communication with the valve 180 and reservoir 12, as depicted in FIG. 8. The fourth conduit 194, like the second conduit 142 discussed above, directs magnetic particle carrier fluid back to the reservoir 12. As with the other conduits, the fourth conduit 194 may be made of any type of material and have any configuration as may be desired for a particular application. Unlike the other conduits, however, the fourth conduit 194 extends between the valve 180 and the reservoir 12, and therefore bypasses the filter(s) 110 and fluorescence reducer 120, redirecting the magnetic particle carrier fluid to the reservoir 12 without being cleaned.

When cleaning is desired, the actuator 182 may be engaged to selectively change from the testing loop 184 to the cleaning loop 186. When this occurs, the valve 180 is adjusted to direct magnetic particle carrier fluid from the valve 180 into a fifth conduit 195. The fifth conduit 195, such as depicted in the exemplary embodiments of FIGS. 10 and 11, is in fluid communication between the valve 180 and at least one of the filter(s) 110 and fluorescence reducer 120. The fifth conduit 195 may be connected to either or both the filter(s) 110 or fluorescence reducer 120, as previously described. An inteiniediate conduit 115 may also be present, as in FIG. 11. The cleaning loop 186 further includes a sixth conduit 196 in fluid communication between the at least one filter(s) 110 or fluorescence reducer 120 and the outlet 140, as in FIGS. 10 and 11. The fifth and sixth conduits 195, 196 of the cleaning loop 186 may be any type, material, and configuration as discussed above for the other conduits.

In some embodiments, the cleaning loop 186 may also include a backflow unit 198 in fluid communication with the sixth conduit 196 leading away from the filter(s) 110 and/or fluorescence reducer 120. The backflow unit 198 minimizes or reduces the reverse flow of magnetic particle carrier fluid back toward the filter(s) 110 and/or fluorescence reducer 120 once cleaned. Accordingly, the backflow unit 198 may be any suitable mechanism, such as but not limited to a backflow fitting, gate valve and ball valve. It may be made of any suitable material, such as aluminum, brass, or other metals, metal alloys, or even plastics and polymers. A backflow unit 198 may also be included in some embodiments of the system 100 that include only a cleaning loop 186.

The magnetic particle carrier fluid recovery system 100 of the present invention may be integrated into existing MPI stations 13, such as shown in FIG. 9. In these embodiments, the system 100 can be inserted or spliced into the tubing that ordinarily leads from the reservoir 12 of magnetic particle carrier fluid 10 to the nozzle 20 which sprays the magnetic particle carrier fluid 10 onto the tested component 18. Accordingly, rather than magnetic particle carrier fluid 10 moving directly from the reservoir 12 to the nozzle 20, it is first directed into the housing 105 and through the testing loop 184 of the system 100. It continues from the outlet 140 of the system through the second conduit 142 to the nozzle 20, where it is sprayed onto the tested component 18 and falls into the reservoir 12 through the slot 16 in the table 17. Such embodiments allow each MPI station or other location to have a dedicated recovery system 100. The dedicated system 100 may be built into the MPI station, or a station may be retrofit with a system 100 as described herein by interposing the system 100 where described above. The system 100 can be selectively toggled between a testing mode and a cleaning mode depending on which action is desired. For instance, when the magnetic particle carrier fluid becomes too contaminated to pass regulations, it may be cleaned with the system 100 by activating the cleaning loop 186, as described above. The cleaning mode may also be run as a preventative or prophylactic measure, such as during routine maintenance, to limit the accumulation of contaminants before the carrier fluid reaches a point that it can no longer be used. In some embodiments, the system 100 may be run in a hybrid mode that permits MPI inspection through partial use of the testing loop 184 while simultaneously providing some cleaning through partial use of the cleaning loop 186. Hybrid mode may not provide the same cleaning efficiency as full cleaning mode, but may provide some relief or can be run in the background as part of maintenance.

In other embodiments, the magnetic particle carrier fluid recovery system 100 of the present invention may be a mobile unit that is portable and can be transported from one location to another. The system 100 may be mounted or secured to a mobile support 170. As shown in FIG. 3, the mobile support 170 may include a horizontal base and/or vertical support on which the housing 105 or components are mounted. The support 170 may also include wheels or other mechanism that facilitates locomotion, although this is not required as the support 170 may simply be carried as well. In other embodiments, the housing 105 may be carried or transported without the need for a support 170. The support 170 may also include a handle to facilitate lifting and directed while transporting or moving the mobile support 170 and system 100. Due to the portability of the mobile support 170, a single system 100 may be brought to each location in need of cleaning, and may be used to clean magnetic particle carrier fluid of multiple MPI stations. This embodiment also permits cleaning while not having to retrofit an MPI station, and may be more economical for facilities that have a small number of MPI stations. The mobile units may also be used to bring the recovery system 100 to storage facilities for the reclamation of contaminated magnetic particle carrier fluid that has been stored for disposal. Accordingly, the system 100 provides a way to recycle the magnetic particle carrier fluid rather than pay to store, dispose and transport the fluid due to contamination.

Regardless of the embodiment, the magnetic particle carrier fluid recovery system 100 of the present invention is capable of cleaning contaminated magnetic particle carrier fluid to a level that is required for new carrier fluid under industry standards and regulations for use in MPI testing. For instance, the system 100 provides complete or near complete reduction of contamination, both physical contaminants and fluorescence. The resulting fluid is clear or very light in color, as compared to brown and cloudy contaminated carrier fluid. This cleaning effect is provided while not adjusting the viscosity of the carrier fluid, which is also regulated since the carrier fluid must be sufficiently viscous to adhere to the tested component during MPI inspection, but not so viscous that it produces false positives in the inspection. The amount of time and number of passes through the cleaning loop of the system 100 to achieve the above-described results may depend at least on the volume of contaminated magnetic particle carrier fluid, the degree and type of contamination, and the configuration of the filter(s) 110 and fluorescence reducer 120.

Notably, the system 100 is capable of producing cleaned magnetic particle carrier fluid that passes industry standard ASTM and AMS tests, including AMS 2641A for petroleum-based magnetic particle inspection, and ASTM E1444 for standard practice for magnetic particle examination. For instance, the cleaned magnetic particle carrier fluid has a viscosity that is not higher than 3.0 centistokes (cSts) at 100° F. and not higher than 5.0 centistokes at the lowest temperature at which the carrier fluid will be used, as determined by ASTM D 445, according to AMS 2641A §3.2.2. It also includes less than 30% particulate matter following a settling period of at least 30 minutes, such as according to ASTM E1444 §§ 7.2.1, or alternatively, less than 1.0 mg/L of particulate matter, as determined by ASTM D 2276, according to AMS 2641A §3.2.4. The cleaned magnetic particle carrier fluid further has a fluorescence less than that of a 10-ppm (1.27×10⁻⁵ molar) solution of quinine sulfate dihydrate in 0.1 N sulfuric acid, as determined by comparison of said magnetic particle carrier fluid to said solution under black light, according to AMS 2641A §3.2.3. The color is not darker than No. 2 ASTM color, as determined in accordance with ASTM D 1500, according to AMS 2641A §3.2.7. It is also free from offensive or disagreeable odor as well as foreign matter, per AMS 2641A §3.2.6 and 3.3.

Because the system 100 cleans by removing particulate matter, it may remove ferromagnetic particles from the magnetic particle carrier fluid during the cleaning process. Therefore, once the magnetic particle carrier fluid is cleaned, it may be reconditioned by adding new ferromagnetic particles until the appropriate concentration level is reached, such as according to ASTM E1444 §5.55. The ferromagnetic particles may be fluorescent or non-fluorescent, such as 14A wet method fluorescent ferromagnetic particles or 7C wet method colored nonfluorescent magnetic particles (Magnaflux, Glenview, Ill.). The cleaned and reconditioned magnetic particle carrier fluid is now ready for reuse or storage.

### EXAMPLE

A system 100 as shown in FIG. 5 was used to treat 10 gallons of contaminated magnetic particle carrier fluid. The first filter 110 was a carbon filter having activated carbon and <1 micron pore size. The second filter 110 was a carbon filter having activated carbon and <5 micron pore size. The system 100 was run at 1.5 gallons per minute at a pressure of <5 psi. Samples were taken at 10 minute increments, with the final sample taken at 180 minutes. The 10-minute sample and 180-minute sample were both sent for analytical testing, which was performed by Sherwin Incorporated of South Gate, Calif. The analytical results are provided below in Table 1.

TABLE 1

| | Viscosity | Background Fluorescence |
|---|---|---|
| Sample | (ASTM E1444) | (ASTM E1444) |
| 10-minute | 2.76 cSts | Conforms |
| 180-minute | 2.75 cSts | Conforms |

The samples were also visibly inspected for color and particulate matter. The 10-minute sample was light yellow in color and clear, as compared to the brown, cloudy untreated magnetic particle carrier fluid. The 180-minute sample was clear and colorless. Both samples also had less than 30% particulate matter by visual inspection. The results of the testing demonstrate that even 10 minutes of using the magnetic particle carrier fluid recovery system 100 is sufficient to clean the carrier fluid to a level that conforms with industry requirements for new magnetic particle carrier fluid.

Since many modifications, variations and changes in detail can be made to the described preferred embodiments, it is intended that all matters in the foregoing description and shown in the accompanying drawings be interpreted as illustrative and not in a limiting sense. Thus, the scope of the invention should be determined by the appended claims and their legal equivalents. Now that the invention has been described,

What is claimed is:

1. A system for cleaning magnetic particle carrier fluid, comprising:
at least one filter configured to remove particulates of less than 1 micron in size from said magnetic particle carrier fluid;
a fluorescence reducer in fluid communication with said at least one filter, said fluorescence reducer configured to remove soluble fluorescent compounds from said magnetic particle carrier fluid;
an inlet in fluid communication with at least one of said at least one filter and said fluorescence reducer;
a first conduit in fluid communication between said inlet and a reservoir of contaminated magnetic particle carrier fluid, said first conduit directing contaminated magnetic particle carrier fluid from said reservoir to said inlet;
an outlet in fluid communication with at least one of said at least one filter and said fluorescence reducer;
a second conduit in fluid communication between said outlet and said reservoir, said second conduit directing substantially cleaned magnetic particle carrier fluid to said reservoir from said outlet; and
a pump configured to circulate said magnetic particle carrier fluid from said reservoir through said first conduit to said inlet, through said inlet to said at least one filter, through said at least one filter to said fluorescence reducer, through said fluorescence reducer to said outlet, through said outlet to said second conduit, and through said second conduit to said reservoir sufficient to achieve substantially clean magnetic particle carrier fluid that has:
(i) less than 30% particulate contaminants following a settling period of at least 30 minutes;
(ii) viscosity of less than 3.0 centistokes at 100° F. and less than 5.0 centistokes at the lowest nominal operating temperature for said magnetic particle carrier fluid; and
(iii) fluorescence less than that of a 10-ppm (1.27×10⁻⁵ molar) solution of quinine sulfate dihydrate in 0.1 N sulfuric acid, as determined by comparison of said magnetic particle carrier fluid to said solution.

2. The system as recited in claim 1, wherein said at least one filter is at least one of a carbon filter, magnetic filter, and reverse osmosis filter.

3. The system as recited in claim 1, wherein said at least one filter is configured to remove particulates in the range of up to 50 microns in size from said magnetic particle carrier fluid.

4. The system as recited in claim 1, wherein said fluorescence reducer is integrated with said at least one filter.

5. The system as recited in claim 1, wherein said fluorescence reducer is at least one of activated carbon and ozone.

6. The system as recited in claim 1, further comprising:
(i) a cleaning loop configured to direct contaminated magnetic particle carrier fluid through said at least one filter and said fluorescence reducer;
(ii) a testing loop configured to bypass said at least one filter and said fluorescence reducer; and
(iii) a valve in fluid communication with said inlet, said valve selectively adjustable to direct said magnetic particle carrier fluid to at least one of said cleaning loop and said testing loop.

7. The system as recited in claim 6, wherein said valve is selectively adjustable to direct said magnetic particle carrier fluid to either said cleaning loop or said testing loop.

8. The system as recited in claim 6, further comprising an actuator in at least one of mechanical and electrical communication with said valve, said actuator selectively engageable to change the state of said valve.

9. The system as recited in claim 6, further comprising a third conduit in fluid communication with said inlet and said valve and directing contaminated magnetic particle carrier fluid to said valve.

10. The system as recited in claim 6, wherein said testing loop comprises a fourth conduit in fluid communication with said valve and said outlet, said fourth conduit directing untreated magnetic particle carrier fluid from said valve to said outlet.

11. The system as recited in claim 6, wherein said cleaning loop comprises:
(i) a fifth conduit in fluid communication with said valve and at least one of said at least one filter and said fluorescence reducer, said fifth conduit directing contaminated magnetic particle carrier fluid to at least one of said at least one filter and said fluorescence reducer; and
(ii) a sixth conduit in fluid communication with at least one of said at least one filter and said fluorescence reducer and said outlet, said sixth conduit directing clean magnetic particle carrier fluid to said outlet.

12. The system as recited in claim 11, wherein said cleaning loop further comprises a backflow unit in fluid communication with said sixth conduit, said backflow unit configured to reduce the flow of clean magnetic particle carrier fluid toward said at least one filter and said fluorescence reducer.

13. The system as recited in claim 1, further comprising a housing dimensioned to receive and retain said at least one filter, said fluorescence reducer, said inlet, and said outlet.

14. The system as recited in claim 1, further comprising a pressure gauge in fluid communication with said first conduit between said pump and at least one of said at least one filter and said fluorescence reducer.

15. The system as recited in claim 14, wherein said system has a pressure less than 60 psi.

16. The system as recited in claim 15, wherein said system has a pressure in the range of 1-60 psi.

17. The system as recited in claim 1, wherein said pump is configured to circulate said magnetic particle carrier fluid at a flow rate in range of 1-60 gallons per minute.

18. The system as recited in claim 1, wherein said system is mobile.

19. The system as recited in claim 1, wherein said system is in association with a magnetic particle inspection station.

20. The system as recited in claim 1, wherein said system is capable of achieving clean magnetic particle carrier fluid that conforms to at least one of AMS 2641A and ASTM E1444 regulation standards.
